(19) United States
(12) Patent Application Publication
(10) Pub. No.: US 2021/0125081 A1
(43) Pub. Date: Apr. 29, 2021

(54) Dynamic Knowledge Transfer

(71) Applicants: Terrrence Nevins, Lynnwood, WA (US); David Young, Bellevue, WA (US); Doug de la Torre, Bellevue, WA (US)

(72) Inventors: Terrrence Nevins, Lynnwood, WA (US); David Young, Bellevue, WA (US); Doug de la Torre, Bellevue, WA (US)

(21) Appl. No.: 16/785,234

(22) Filed: Feb. 7, 2020

Related U.S. Application Data
(60) Provisional application No. 62/802,390, filed on Feb. 7, 2019.

(51) Int. Cl. G06N 5/02

(52) U.S. Cl. CPC G06N 5/02

(57) ABSTRACT

Dynamic knowledge transfer may provide a system and method for creating modules, for example, crowd-sourced or employee-curated trainings, instruction manuals, or tutorials, comprising dynamic, as opposed to fixed, streams of information. Dynamic knowledge transfer may provide significant improvements to sharing or retention of information, benefitting desk-less workers or other users who will be enabled to make revisions or submit new content to keep the information up-to-date and relevant.

### FIELD

This disclosure relates to dynamic knowledge transfer.

### BACKGROUND

Transfer of knowledge is conventionally performed in a fixed, unidirectional manner. Trainings, instruction manuals, or tutorials, for example, typically provide pre-packaged information to be consumed by an end user. Conventional knowledge transfer is not conducive to feedback, revision, or collaboration, greatly diminishing its quality and effectiveness.

### SUMMARY

The instant application discloses, among other things, techniques to allow dynamic knowledge transfer. Dynamic knowledge transfer may provide significant improvements to knowledge sharing and retention. Among other things, it may provide a method and system for creating crowd-sourced training modules comprising dynamic, as opposed to fixed, streams of information.

In one implementation, dynamic knowledge transfer may comprise a software application operable to run on a mobile device. The application may enable a user to create a module and utilize capabilities on the mobile device, such as a camera, a keyboard, or a location tracking feature, to add relevance to the module. The module may comprise a crowd-sourced training, an instruction manual, or a video tutorial, for example. The creator of the module or other users may continually submit new content, remove content, revise content, rearrange a history or sequence, or provide ratings or rankings so that a module remains up-to-date and relevant. Dynamic knowledge transfer may particularly benefit desk-less workers, enabling them to collaboratively share or retain relevant knowledge while working away from a desktop computer or in the field.

### BRIEF DESCRIPTION OF THE DRAWINGS

The present description may be better understood from the following detailed description read in light of the appended drawings, wherein:

FIG. 1 is a flowchart for dynamic knowledge transfer, according to one implementation.

FIG. 2 is a block diagram illustrating an example of a system capable of supporting dynamic knowledge transfer, according to one implementation.

FIG. 3 is a component diagram of a computing device that may support dynamic knowledge transfer, according to one implementation.

### DESCRIPTION

A more particular description of certain implementations of dynamic knowledge transfer may be had by references to the implementations shown in the drawings that form a part of this specification, in which like numerals represent like objects.

The illustrated operations in the description show certain events occurring in a certain order. One skilled in the art will recognize that certain operations may be performed in a different order, modified or removed. Moreover, steps may be added to the described logic and still conform to the described implementations.

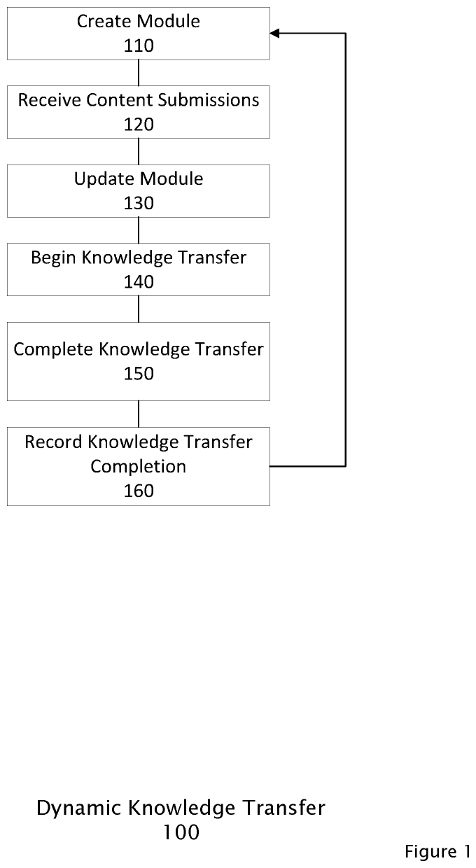

FIG. 1 is a flowchart for Dynamic Knowledge Transfer 100, according to one implementation. Dynamic Knowledge Transfer 100 may provide significant improvements to knowledge sharing and retention. Among other things, it may provide a method and system for creating modules that comprise dynamic, as opposed to fixed, streams of information.

In one implementation, Dynamic Knowledge Transfer 100 may comprise a system, such as a software application, operable to run on a mobile device. At Create Module 110, the system may enable a user to create a module comprising, for example, an employee training, a product instruction manual, a video tutorial, or other forms of knowledge transfer. The module may provide information on a superior or preferred method relating to a workplace, product, or activity. For example, a warehouse foreman may create a module centered on best practices for operating a newly-purchased electric forklift. Instead of a fixed, static training or instruction manual, for example, the module may become more like a living document.

At Receive Content Submissions 120, the system may utilize capabilities on the mobile device, such as a camera, a keyboard, or a location tracking feature, to add relevance to the module. The creator of the module or other users viewing the module may continually submit new content, remove content, revise content, rearrange a sequence or history, or provide ratings or rankings, for example, so that a module remains up-to-date and relevant.

The system may receive an input of content, which may comprise digital or analog images, videos, sounds, tactile items, or scents, for example, in any format or medium. The content provider may be an individual, entity, or the public, for example. The content provider may upload the content to the Dynamic Knowledge Transfer 100 system, or the system may receive the content by another means, for example, by utilizing a third-party program or an Internet web crawler to pull data.

At Receive Content Submissions 120, the module creator may invite employees to take or submit photos that communicate essential visuals needed for training on a use of the forklift. Employees may take or submit photos pertaining to any topic, contributing to the showcase. The employees may vote or predict top entries based on a quality of photos that express the theme for each showcase, for example, overweight load, battery low, or traffic pattern rules. The submitted photos may be specific to nuances to the employer's workplace operations or crew, for example.

For example, if a video frame in a training module created by a first user appears blurry, a second user may locate and replace the blurry frame with a non-blurry frame, improving the training video. In another example, if a user determines that steps in a machine assembly tutorial module are better performed in another sequence, the user may re-order the sequence of steps of the tutorial. Other users may rate various modules, providing guidance on an effectiveness of a module.

It may the location tracking feature on a mobile device to determine a user's geolocation and offer context. For example, if a user's device is in a geolocation of a car repair shop and that user is an employee, then the Dynamic Knowledge Transfer 100 system may provide information about how a degreaser is maintained at that location. Dynamic knowledge transfer may provide steps that Frank, an experienced employee at that location, has been taking with this customer system for the last five years.

Dynamic Knowledge Transfer 100 may provide context sensitivity. For example, triggers such as geolocation may prompt a training or suggest a training on some sort of relevant knowledge. For example, an elapsed time of 15 minutes after a start of a worker's shift may prompt a relevant training based on that context. In another implementation, a user may take a picture of a bookshelf. The program may return a stream of modules produced for assembling that bookshelf by the community, or one module, which had been refined over 70 different assemblies. As another example, a user may receive a suggestion to get a different type of tool that works better, for example, a laser leveler.

A series of photos may communicate a preferred or superior way of accomplishing a task. A user may enter a caption or other information with each photo. A user may vote on a series of photos. Awards or rewards may be given for content. For example, a user who produces a lot of content that gets utilized by a workforce may be designated a leader or expert in a field, and other users may rank second, third, and so forth. A user may know who is authoring a mobile, enabling ownership associated with a module. A user may also know how many times a module is used, where it was used, or who used it. Because a user may know who created a module, the program may lend credibility to creators or owners. For example, a creator's face may appear next to a training module icon.

The application may be optimized for use on a mobile device. In another implementation, it may be optimized for personal or desktop computers or other devices.

At Update 130, the system may continuously update the module based on content submissions received.

Dynamic Knowledge Transfer 100 may enable a user to keep information in a module to themselves and choose not to share it with others, allowing for knowledge retention.

A module may be searchable. There may be different classifications for sets of modules. For example, one set of modules may be for senders. Another set of modules may be for people that service products. Another set of modules may be for people that handle returns. A user may see relevant modules that are related to that worker's role in an organization.

Dynamic Knowledge Transfer 100 may include an artificial intelligence (AI) component. For example, it may tell a user an exact location or timestamp in a video where one needs to watch, or it may extract the pictures directly from the video to do it.

Dynamic Knowledge Transfer 100 may provide an alternative version of a training, or components of a training. For example, it may have five photos of an assembled machine and provide rankings for most popular, most favorited, or most highly-reviewed photos of the assembled machine. It may provide an indicator, for example, a visual graphic showing how a photo was rated, how much it applied, or other relevant statistics.

At Begin Knowledge Transfer 140, a user may begin reading, viewing, or engaging in a crowd-sourced training, instruction manual, or video tutorial, for example. In one implementation, a user may tap on a picture to receive information or an audio clip. A module may be received from a peer, subscription, marketplace, or means of exchange or something a user has done. Dynamic Knowledge Transfer 100 may particularly benefit desk-less workers, enabling them to collaboratively share or retain relevant knowledge while working away from a desktop computer or in the field. The modules may be optimized, changed, adapted, and always available to remote or desk-less workers who have a mobile device.

This may provide an improvement in knowledge transfer, for example, by optimizing quality or efficacy of the training or transfer of knowledge. Instead of a unidirectional or up-down training, it may enable crowd-sourced or grassroots training that may scale with a company or organization. Workers who have the most hands-on knowledge, for example, technicians, may be invested in creating the content. It may engage end-people who are going to use it. It may promote a collaborative process to gain new efficiencies or ideas, capture innovation, or stay abreast of a business, for example.

At Complete Knowledge Transfer 150, the user may complete the crowd-sourced module. For example, the user may complete performing all training tasks, reading all pages of an instruction manual, or viewing all frames in a video tutorial, for example. At Record Knowledge Transfer Completion 160, the system may input information into a record-keeping database to indicate that a user, such as a new employee, has completed the module. In one implementation, Dynamic Knowledge Transfer 100 may allow for context-specific crowd-sourced training for employees or other users. For example, users may publish, submit, or contribute best practices for performing maintenance or being safe on a job site. This may improve the effectiveness of training materials by enlisting expertise or experience of an employer's workforce, for example, desk-less workers working in the field. Training may always be current and relevant because it may be constantly updated with submissions from employees, contractors, or other parties. Participants may vote for or predict top submissions describing best practices.

Dynamic Knowledge Transfer 100 may extract data from people using them, for example, take accounting for completion of a task. For example, it may record a period time it takes for a person to swipe through a training and click “Done.” This may help baseline how long it takes to service a product, for example. This may allow a company to facilitate scheduling or calculate expected sales. For example, a company may determine it can perform 25 annual water cooler inspections in one day in a geolocation.

It may include compliance features. For example, a user may not receive access to instructions to repair a machine until that user confirms that he or she has unplugged the machine. Or, it may require a user to provide proof showing another qualification, such as a license number or possession of a required tool, for example, a voltmeter.

Dynamic knowledge transfer may provide information on how to service or use a type of equipment to improve service or keep service consistent so that the business does not fail a customer or a product. For example, an employee who needs to perform an annual service on a product can refer to the company “playbook” and get it right the first time. If a company sees that a company procedure has been revised 50 times, the company may be alerted to the fact that there is an inconsistency in implementing or enforcing the procedure, and something should be changed.

Dynamic Knowledge Transfer 100 may learn trends, best practices, popular methods, or rejected or unpopular methods, for example. It may recognize information through image recognition or machine learning.

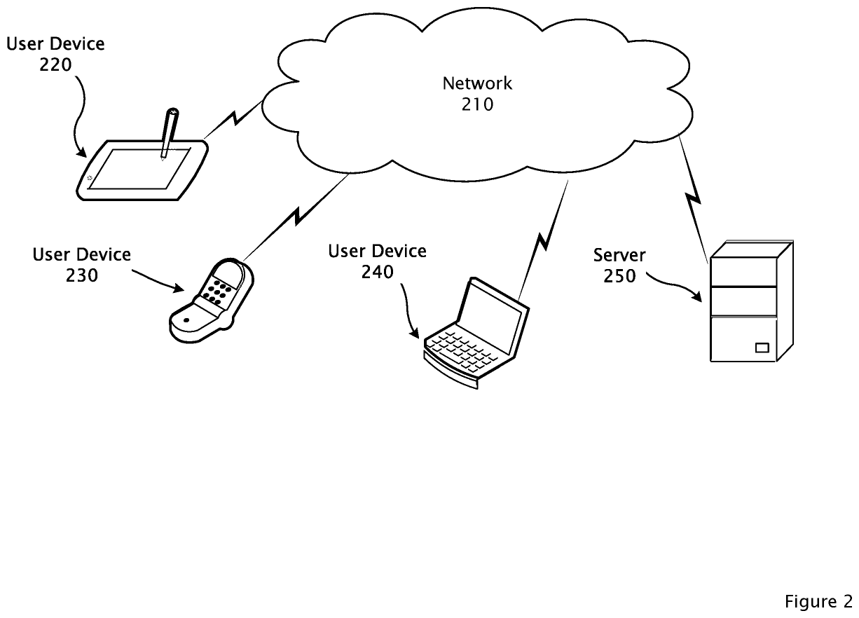

FIG. 2 is a block diagram illustrating an example of a system capable of supporting Dynamic Knowledge Transfer, according to one implementation. Network 210 may include Wi-Fi, cellular data access methods, such as 3G or 4GLTE, Bluetooth, Near Field Communications (NFC), the internet, local area networks, wide area networks, or any combination of these or other means of providing data transfer capabilities. In one implementation, Network 210 may comprise Ethernet connectivity. In another implementation, Network 210 may comprise fiber-optic connections.

User Device 220, 230, or 240 may have network capabilities to communicate with Server 250. Server 250 may include one or more computers, and may serve a number of roles. Server 250 may be conventionally constructed, or may be of a special purpose design for processing data obtained from Dynamic Knowledge Transfer. One skilled in the art will recognize that Server 250 may be of many different designs and may have different capabilities.

User Device 220, 230, or 240 may be used by content creators or editors, for example, by accessing a website or executing an app. Server 250 may be used to host a website, allow content creation or editing, or perform other tasks. One having skill in the art will recognize that various configurations for User Device 220, 230, or 240 and Server 250 may be used to implement Dynamic Knowledge Transfer.

In one implementation, content may be stored on Server 250, which may provide content on-demand or may push content out to User Device 220, 230, or 240.

In another implementation, content may be distributed across multiple devices, User Device 220, 230, or 240, for example. In one implementation, User Device 220, 230, or 240 may be connected via a mesh network. One having skill in the art will recognize that various ways of storing content and various network configurations may be used to support Dynamic Knowledge Transfer.

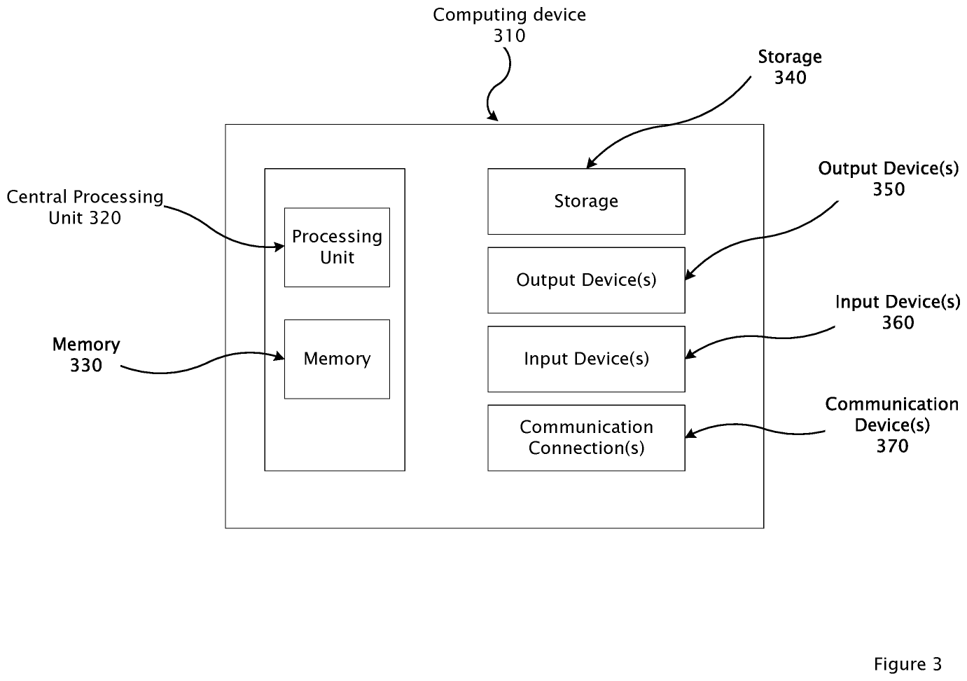

FIG. 3 is a component diagram of a computing device that may support Dynamic Knowledge Transfer, according to one implementation.

Computing Device 310 can be utilized to implement one or more computing devices, computer processes, or software modules described herein, including, for example, but not limited to a mobile device. In one example, Computing Device 310 can be used to process calculations, execute instructions, and receive and transmit digital signals. In another example, Computing Device 310 can be utilized to process calculations, execute instructions, receive and transmit digital signals, receive and transmit search queries and hypertext, and compile computer code suitable for a mobile device. Computing Device 310 can be any general or special purpose computer now known or to become known capable of performing the steps or performing the functions described herein, either in software, hardware, firmware, or a combination thereof.

In its most basic configuration, Computing Device 310 typically includes at least one Central Processing Unit (CPU) 320 and Memory 330. Depending on the exact configuration and type of Computing Device 310, Memory 330 may be volatile (such as RAM), non-volatile (such as ROM, flash memory, etc.) or some combination of the two. Additionally, Computing Device 310 may also have additional features/functionality. For example, Computing Device 310 may include multiple CPUs. The described methods may be executed in any manner by any processing unit in Computing Device 310. For example, the described process may be executed by both multiple CPUs in parallel.

Computing Device 310 may also include additional storage (removable or non-removable) including, but not limited to, magnetic or optical disks or tape. Such additional storage is illustrated by Storage 340. Computer-readable storage media includes volatile and nonvolatile, removable and non-removable media implemented in any method or technology for storage of information such as computer-readable instructions, data structures, program modules, or other data. Memory 330 and Storage 340 are all examples of computer-readable storage media. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by Computing Device 310. Any such computer-readable storage media may be part of Computing Device 310. But computer-readable storage media does not include transient signals.

Computing Device 310 may also contain Communications Device(s) 370 that allow the device to communicate with other devices. Communications Device(s) 370 is an example of communication media. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 310 may also have Input Device(s) 360, such as a keyboard, mouse, pen, voice input device, touch input device, etc. Output Device(s) 350 such as a display, speakers, printer, etc. may also be included. All these devices are well-known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described implementations may be made without departing from the spirit and scope of the invention.

Additionally, the illustrated operations in the description show certain events occurring in a certain order. In alternative implementations, certain operations may be performed in a different order, modified or removed. Moreover, steps may be added to the above-described logic and still conform to the described implementations. Further, operations described herein may occur sequentially, or certain operations may be processed in parallel. Yet further operations may be performed by a single processing unit or by distributed processing units.

1. A method, comprising:
receiving a first content on how to use a first device or how to perform a multi-step operation at a second device;
sharing the first content with a first set of users;
allowing at least one user from the first set of users to update the first content;
receiving a second content from the at least one of the first set of users, the second content including at least a portion of the first content; and
sharing the second content with a second set of users.

2. The method of claim 1 wherein the first content comprises video.

3. The method of claim 1 wherein the first content comprises a picture.

4. The method of claim 1 wherein the first content comprises audio.

5. The method of claim 1, wherein the first content comprises text.

6. A system, comprising:
a first user device, the first user device capable of creating a first content;
a second user device, the second user device capable of receiving the first content, editing the first content, giving a second content, the second content comprising at least a subset of the first content; and
a third device, the third device capable of receiving the second content.
